(19) United States
(12) Patent Application Publication
(10) Pub. No.: US 2022/0081006 A1
(43) Pub. Date: Mar. 17, 2022

(54) VEHICLE AND AUTONOMOUS DRIVING CONTROL METHOD THEREFOR

(71) Applicants: HYUNDAI MOTOR COMPANY, Seoul (KR); KIA CORPORATION, Seoul (KR)

(72) Inventor: Dong Hoon Kang, Seoul (KR)

(21) Appl. No.: 17/389,893

(22) Filed: Jul. 30, 2021

(30) Foreign Application Priority Data
Sep. 15, 2020 (KR) 10-2020-0118096

(51) Int. Cl. B60W 60/00; B60W 30/18

(52) U.S. Cl. CPC B60W 60/0027; B60W 2754/30; B60W 2554/4041; B60W 2554/4046; B60W 2554/402; B60W 2554/4042; B60W 2554/4043; B60W 2555/60; B60W 2554/804; B60W 2554/803; B60W 2556/45; B60W 2556/65; B60W 2554/4045; B60W 2754/20; B60W 30/18163

(57) ABSTRACT

A vehicle and an autonomous driving control method therefore may include detecting traffic environment information around a host vehicle, determining traffic flow in a host vehicle lane and a neighboring lane adjacent to the host vehicle lane according to the traffic environment information, and generating a driving strategy based on the traffic flow to control driving of the host vehicle according to the generated driving strategy.

The present application claims priority to Korean Patent Application No. 10-2020-0118096, filed on Sep. 15, 2020, the entire contents of which is incorporated herein for all purposes by this reference.

### BACKGROUND OF THE INVENTION

### Field of the Invention

The present invention relates to an autonomous driving control method optimized for realizing smooth traffic flow.

### Description of Related Art

An autonomous vehicle applies an advanced driver assistance system (ADAS) to free a driver from the need to perform simple operations such as manipulation of a steering wheel and a pedal while the vehicle is traveling and also to prevent accidents due to carelessness of the driver, and thus has recently attracted increased attention.

However, such a conventional autonomous vehicle is designed to control driving within a speed range that does not exceed the speed limit of the road on which the vehicle is traveling. In many actual cases, however, drivers drive the vehicles at a speed higher than the speed limit. Furthermore, if the vehicles are controlled based only on the speed limit in various traffic situations, this may impede the surrounding traffic flow.

Therefore, there is demand for the development of an autonomous driving control method optimized for realizing smooth traffic flow in a variety of traffic situations.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle and an autonomous driving control method therefor that substantially obviate one or more problems due to limitations and disadvantages of the related art.

Embodiments provide an autonomous driving control method configured for determining traffic flow in the vicinity of a host vehicle and establishing a driving control strategy suitable for respective traffic situations, eliminating hindrance to traffic flow caused by unconditional compliance with road traffic regulations.

However, the objects to be accomplished by the exemplary embodiments are not limited to the above-mentioned objects, and other objects not mentioned herein will be clearly understood by those skilled in the art from the following description.

An autonomous driving control method according to various exemplary embodiments of the present invention may include detecting traffic environment information around a host vehicle, determining traffic flow in a host vehicle lane and a neighboring lane adjacent to the host vehicle lane according to the traffic environment information, and generating a driving strategy optimized for the traffic flow to control driving of the host vehicle according to the generated driving strategy.

The determining the traffic flow may include determining whether the motion of a preceding vehicle is abnormal, determining whether the host vehicle is impeding the traffic flow, and determining whether at least one autonomous vehicle is present near the host vehicle.

The determining whether the motion of the preceding vehicle is abnormal may include a first step of detecting a motion outlier of the preceding vehicle and determining whether the motion outlier is greater than a predetermined reference value, a second step of determining whether the preceding vehicle corresponds to a predetermined type of vehicle to be avoided, and a third step of determining whether the speed of the preceding vehicle is lower than the minimum speed limit of the road corresponding to the current location of the host vehicle.

The controlling driving of the host vehicle may include, when at least one condition among the first to third steps is satisfied, performing a lane change in the manner of increasing the speed of the host vehicle or controlling steering of the host vehicle toward the neighboring lane.

The motion outlier may include at least one of a distance that the center portion of the preceding vehicle is deflected from the middle portion of the host vehicle lane in a lateral direction or the number of sudden steering operations of the preceding vehicle.

The determining whether the host vehicle is impeding the traffic flow may include comparing the speed of the host vehicle with the speed of a neighboring vehicle, counting the number of vehicles that cut in front of the host vehicle during a predetermined amount of time, and searching for a preceding vehicle having a speed pattern similar to the target speed of the host vehicle.

The searching for the preceding vehicle may be performed when the speed of the host vehicle is higher than or equal to the speed of the neighboring vehicle or when the counted number of vehicles is less than a predetermined threshold value.

The controlling driving of the host vehicle may include, when the speed of the host vehicle is lower than the speed of the neighboring vehicle, generating the driving strategy for cut-in yield control to reduce the speed of the host vehicle.

The determining whether at least one autonomous vehicle is present may include receiving a V2X message from the at least one autonomous vehicle or external traffic infrastructure, detecting a cut-in-requesting vehicle based on the V2X message and determining whether a target driving lane of the detected cut-in-requesting vehicle is the host vehicle lane, and when the target driving lane is the host vehicle lane, comparing the speed of the host vehicle with the speed of the cut-in-requesting vehicle and transmitting a scheduling message to the at least one autonomous vehicle in consideration of the current driving lane of the at least one autonomous vehicle.

The scheduling message may include control information to adjust the distance between the host vehicle and the at least one autonomous vehicle and the traveling speeds of the host vehicle and the at least one autonomous vehicle.

An autonomous driving control apparatus according to various exemplary embodiments of the present invention may include a sensor configured to detect traffic environment information around a host vehicle, a traffic flow determiner electrically connected to the sensor and configured to determine traffic flow in a host vehicle lane and a neighboring lane adjacent to the host vehicle lane based on the traffic environment information, and a driving controller electrically connected to the traffic flow determiner and configured to generate a driving strategy according to the determined traffic flow and to control driving of the host vehicle according to the generated driving strategy.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram showing an autonomous driving control apparatus according to various exemplary embodiments of the present invention;

FIG. 2 is a diagram showing a traffic situation according to various exemplary embodiments;

FIG. 3 is a flowchart of a vehicle control process for responding to the traffic situation shown in FIG. 2;

FIG. 4 is a diagram showing a traffic situation according to various exemplary embodiments;

FIG. 5 is a flowchart of a vehicle control process for responding to the traffic situation shown in FIG. 4; and

FIG. 6 is a flowchart of a vehicle control process for responding to a traffic situation according to various exemplary embodiments.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Reference will now be made in detail to the embodiments, examples of which are illustrated in the accompanying drawings. While the present invention is susceptible to various modifications and alternative forms, specific embodiments thereof are shown by way of example in the drawings. However, the present invention may not be construed as being limited to the exemplary embodiments set forth herein, but on the other hand, the present invention is to cover all modifications, equivalents, and alternatives falling within the spirit and scope of the embodiments.

It may be understood that, although the terms “first”, “second”, etc. may be used herein to describe various elements, these elements are not to be limited by these terms. These terms are generally only used to distinguish one element from another. Furthermore, terms particularly defined in consideration of the construction and operation of the exemplary embodiments are used only to describe the embodiments, but do not define the scope of the embodiments.

The terminology used herein is for describing various exemplary embodiments only and is not intended to be limiting of exemplary embodiments. As used herein, the singular forms “a”, “an”, and “the”, are intended to include the plural forms as well, unless the context clearly indicates otherwise. It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, an autonomous driving control apparatus according to an exemplary embodiment will be described with reference to the accompanying drawings.

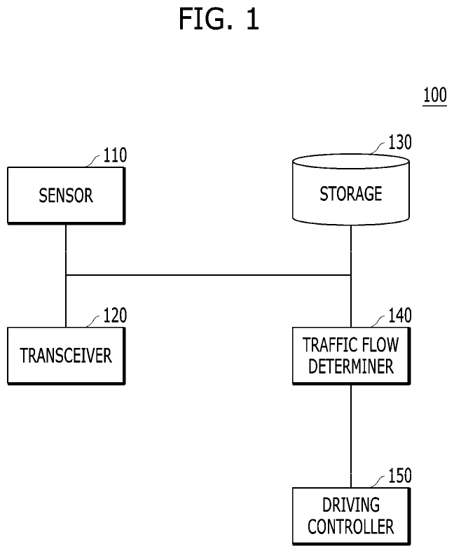

FIG. 1 is a block diagram showing an autonomous driving control apparatus according to various exemplary embodiments of the present invention.

Referring to FIG. 1, the autonomous driving control apparatus 100 may include a sensor 110, a transceiver 120, a storage 130, a traffic flow determiner 140, and a driving controller 150.

The sensor 110 may include an external sensor for detecting information on the environment surrounding a host vehicle in real time and an internal sensor for measuring information on the state of the host vehicle. The external sensor may include an image sensor, a distance measurement sensor, and a global positioning system (GPS) receiver, which are provided on at least one of the front side, the lateral side, or the rear side of the vehicle. Here, the information on the environment surrounding the host vehicle may include the driving lane of the host vehicle and the driving state of a neighboring vehicle, which is traveling in a lane adjacent to the driving lane of the host vehicle.

The image sensor may collect information on the images of the surroundings of the vehicle captured by an optical system, and may perform image processing such as removal of noise, adjustment of image quality and saturation, and file compression with respect to the image information.

The distance measurement sensor may measure the distance from the vehicle to an object or the relative speed of the object, and may be implemented as a radio detection and ranging (RaDAR) sensor or a light detection and ranging (LiDAR) sensor. A RaDAR sensor measures the distance to an object present near the vehicle, the heading of the object, the relative speed of the object, and the altitude of the object using electromagnetic waves, and is configured for achieving long-distance recognition and performing the functions thereof in bad weather. A Light Detection and Ranging (LiDAR) sensor radiates a laser pulse toward a region ahead of the vehicle on a road and generates point-shaped LiDAR data from a laser pulse reflected from an object or the like. Such a LiDAR sensor has a precise resolution, and thus is mainly used to detect an object present near the vehicle.

The Global Positioning System (GPS) receiver is a sensor configured to estimate the geographic location of the vehicle. The GPS receiver may receive a navigation message from a GPS satellite located far from the earth surface, and may collect information on the current location of the vehicle in real time based thereon.

The internal sensor may include a speed sensor, an acceleration sensor, and a steering angle sensor for respectively measuring the current speed, the acceleration, and the steering angle of the vehicle, and may periodically collect information on the states of various actuators.

The transceiver 120 may be provided with a communication interface supporting V2X (Vehicle to X) communication, and may acquire information on the traffic situation through periodic communication with a neighboring vehicle and external traffic infrastructure. Here, the “X” in “V2X” indicates everything, i.e., Infrastructure/Vehicle/Nomadic-device and the like, and V2X represents all types of communication schemes which may be possibly applied to vehicles. Furthermore, V2X refers to specific communication technology for implementing a general “Connected Vehicle” or “Networked Vehicle”. V2X communication may be broadly classified into three categories: communication between a vehicle and infrastructure (Vehicle-to-Infrastructure (V2I)), communication between vehicles (Vehicle-to-Vehicle (V2V)), and communication between a vehicle and a mobile device (Vehicle-to-Nomadic device (V2N)), and other types of communication categories may be further included therein.

The transceiver 120 may receive a V2X message from an autonomous vehicle and/or external traffic infrastructure around the host vehicle, and may broadcast a scheduling message generated by the driving controller 150, which will be described later, to an autonomous vehicle provided with a V2X communication interface.

The storage 130 may store, in advance, reference information for determining the traffic flow in the vicinity of the host vehicle. Here, the reference information may include a reference value associated with a motion outlier of a preceding vehicle, which will be described later, a list of vehicle types associated with vehicles to be avoided, and a threshold value associated with the number of times that neighboring vehicle(s) have cut in front of the host vehicle. The storage 130 may be implemented as at least one storage medium selected among flash memory, a hard disk, a Secure Digital (SD) card, Random Access Memory (RAM), Read-Only Memory (ROM), and web storage.

The traffic flow determiner 140 may determine the traffic flow in the driving lane and the neighboring lane based on information on the traffic situation in the vicinity of the host vehicle, which is transmitted through the sensor 110 and/or the transceiver 120. For example, the traffic flow determiner 140 may determine whether the motion of the preceding vehicle is abnormal, whether the host vehicle is impeding the traffic flow, and whether at least one autonomous vehicle is present near the host vehicle, and may transmit the result of the determination to the driving controller 150.

The driving controller 150 may control a lower-level controller in the state of setting a preceding-vehicle-based autonomous driving control as a default, may generate a driving strategy optimized for the traffic flow determined by the traffic flow determiner 140, and may actively control driving of the host vehicle according to the generated driving strategy.

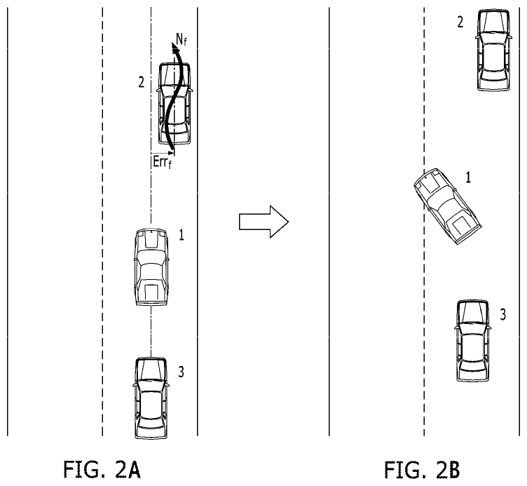

The autonomous driving control apparatus 100 according to an exemplary embodiment determines the traffic flow in the vicinity of the host vehicle and establishes a driving control strategy suitable for respective traffic situations, eliminating hindrance to the traffic flow caused by unconditional compliance with road traffic regulations. Furthermore, it is possible to adjust a passive driving control strategy to actively respond to respective traffic situations, inducing smooth traffic flow in the vicinity of the host vehicle. A detailed description thereof will be made below with reference to FIGS. 2 to 6.

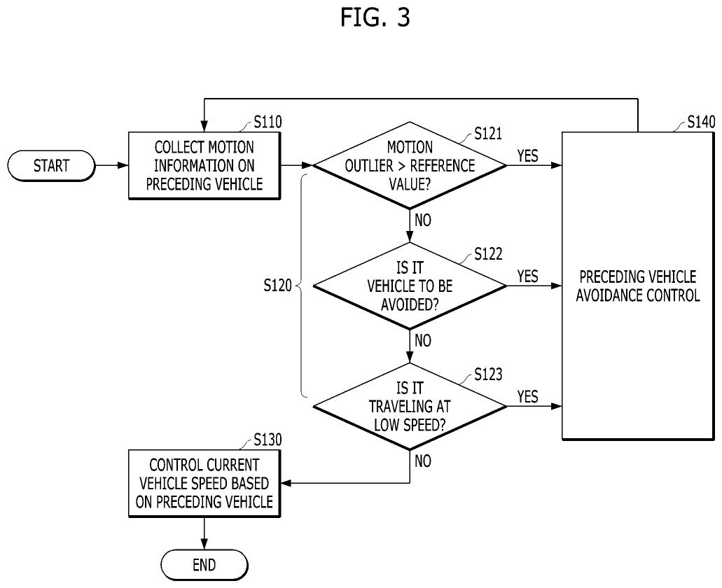

FIG. 2 is a diagram showing a traffic situation according to various exemplary embodiments. FIG. 3 is a flowchart of a vehicle control process for responding to the traffic situation shown in FIG. 2.

Referring to FIG. 2 and FIG. 3, the sensor 110 may collect status information and driving information on a preceding vehicle 2 using at least one external sensor, which is provided on the front side, the lateral side, or the rear side of a host vehicle 1, and an internal sensor (S110). Here, the status information may include information on the type of the preceding vehicle 2, and the driving information may include information on the speed of the preceding vehicle 2, the steering pattern of the preceding vehicle 2, and the location of the preceding vehicle 2 in the driving lane.

The traffic flow determiner 140 may determine whether the motion of the preceding vehicle 2 is abnormal based on the collected status information and driving information on the preceding vehicle 2, and when the motion of the preceding vehicle 2 does not satisfy a preset normal motion condition, may generate a trigger signal, and may transmit the same to the controller 150 (S120).

First, the traffic flow determiner 140 may detect a motion outlier based on the driving information on the preceding vehicle 2, may read a reference value stored in advance in the storage 130, and may compare the motion outlier with the reference value (S121).

Here, the motion outlier may be determined based on a deflection distance Err_{f} and/or the number of sudden steering operations N_{f} of the preceding vehicle 2. For example, the traffic flow determiner 140 may measure the distance that the center portion of the preceding vehicle 2 is deflected from the middle portion of the driving lane in the lateral direction thereof, determining the deflection distance Err_{f}. Furthermore, the traffic flow determiner 140 may count the number of times that the steering pattern of the preceding vehicle 2 changes suddenly within a predetermined amount of time, detecting the number of sudden steering operations N_{f} (refer to FIG. 2A).

In an exemplary embodiment of the present invention, the traffic flow determiner 140 may count the number of times in which the steering angle of the preceding vehicle 2 may change greater than an predetermined angle to determine how suddenly the steering pattern of the preceding vehicle 2 changes.

In step S121, when it is determined that the deflection distance Err_{f} of the preceding vehicle 2 is greater than a first reference value Errₐᵥₐᵢₗ or that the number of sudden steering operations N_{f} is greater than a second reference value Nₐᵥₐᵢₗ (Yes in S121), the traffic flow determiner 140 may generate a trigger signal. Here, the first and second reference values Errₐᵥₐᵢₗ and Nₐᵥₐᵢₗ are threshold values, based on which the motion of the preceding vehicle 2 may be considered to be normal. The first and second reference values Errₐᵥₐᵢₗ and Nₐᵥₐᵢₗ may be set in advance by a developer.

On the other hand, when it is determined that the deflection distance Err_{f} of the preceding vehicle 2 is less than or equal to the first reference value Errₐᵥₐᵢₗ and that the number of sudden steering operations N_{f} is less than or equal to the second reference value Nₐᵥₐᵢₗ (No in S121), the traffic flow determiner 140 may determine whether the preceding vehicle 2 is a vehicle to be avoided based on the status information on the preceding vehicle 2 (S122).

In step S122, the traffic flow determiner 140 reads the list of vehicle types associated with vehicles to be avoided, which is stored in advance in the storage 130, and determines whether the preceding vehicle 2 located ahead of the host vehicle 1 is a vehicle to be avoided. Here, the vehicles to be avoided may include dump trucks, tractor trailers, excavators, cement mixers, large buses, and the like, but this is merely given by way of example.

Upon determining that the preceding vehicle 2 is a vehicle to be avoided (Yes in S122), the traffic flow determiner 140 generates a trigger signal. Upon determining that the preceding vehicle 2 is not a vehicle to be avoided (No in S122), the traffic flow determiner 140 determines whether the preceding vehicle 2 is traveling at a low speed based on the driving information on the preceding vehicle 2 (S123).

In step S123, the traffic flow determiner 140 determines the current speed V_{f} of the preceding vehicle 2 using the relative speed of the preceding vehicle 2 and the absolute speed of the host vehicle 1, which are measured by the sensor 110, and determines whether the speed V_{f} of the preceding vehicle 2 is lower than the minimum speed limit V_{avail_min} of a road. Here, the minimum speed limit V_{avail_min} of the road is a minimum legal speed on the portion of the road corresponding to the current location of the host vehicle 1 measured by the Global Positioning System (GPS) sensor. The minimum speed limit V_{avail_min} of the road may be stored in advance in the storage 130. Furthermore, when a following vehicle 3 is present behind the host vehicle 1, the traffic flow determiner 140 determines the current speed V_{b} of the following vehicle 4, and determines whether the speed V_{f} of the preceding vehicle 2 is lower than the speed V_{b} of the following vehicle 4.

When the speed V_{f} of the preceding vehicle 2 is lower than the minimum speed limit V_{avail_min} of the road and is lower than the speed V_{b} of the following vehicle 3 (Yes in S123), the traffic flow determiner 140 may generate a trigger signal.

On the other hand, when the speed V_{f} of the preceding vehicle 2 is higher than or equal to the minimum speed limit V_{avail_min} of the road or is higher than or equal to the speed V_{b} of the following vehicle 3 (No in S123), the traffic flow determiner 140 may determine that the motion of the preceding vehicle 2 is normal, and the driving controller 150 may control the current speed of the host vehicle 1 based on the preceding vehicle 2 according to default autonomous driving control setting (S130).

On the other hand, upon receiving the trigger signal from the traffic flow determiner 140 (Yes in each of S121, S122 and S123), the driving controller 150 may generate a driving strategy for avoiding the preceding vehicle 2, and may perform a lane change in the manner of increasing the speed of the host vehicle 1 or controlling the steering of the host vehicle 1 toward a neighboring lane (S140) (refer to FIG. 2B).

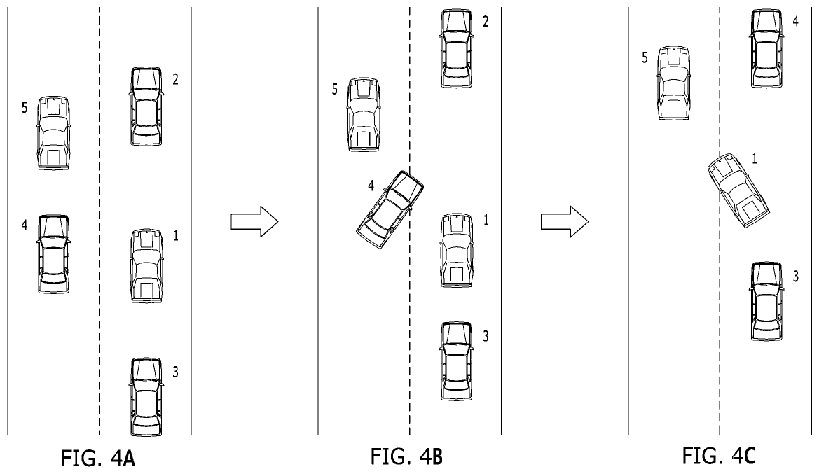

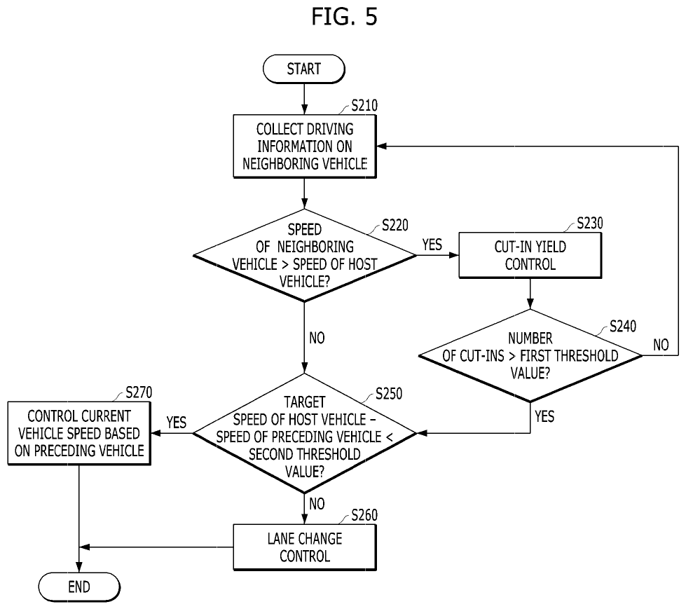

FIG. 4 is a diagram showing a traffic situation according to various exemplary embodiments. FIG. 5 is a flowchart of a vehicle control process for responding to the traffic situation shown in FIG. 4.

Referring to FIG. 4 and FIG. 5, the sensor 110 may collect driving information on the host vehicle 1 and neighboring vehicles 2, 3, 4 and 5 using at least one external sensor, which is provided on the front side, the lateral side, or the rear side of the host vehicle 1, and an internal sensor (S210). Here, the neighboring vehicles 2, 3, 4 and 5 are other vehicles that are traveling in the driving lane of the host vehicle 1 and a neighboring lane adjacent to the driving lane of the host vehicle 1.

The traffic flow determiner 140 may determine the possibility of overtaking of the following vehicle 3 or the possibility of cut-in of the vehicle 4 traveling in the neighboring lane based on the collected driving information on the host vehicle 1 and the neighboring vehicles 2, 3, 4 and 5 (S220). To the present end, the traffic flow determiner 140 may compare the current speed Vₘ of the host vehicle 1 with the current speeds V_{f1}, V_{b}, Vₛ and V_{f2} of the neighboring vehicles 2, 3, 4 and 5 (refer to FIG. 4A).

When the speed Vₘ of the host vehicle 1 is lower than the speed V_{f1} of the preceding vehicle 2, is lower than the speed V_{b} of the following vehicle 3, and is lower than the speed Vₛ of the vehicle 4 traveling in the neighboring lane (Yes in S220), the traffic flow determiner 140 may generate a first trigger signal, and may transmit the same to the driving controller 150.

Upon receiving the first trigger signal from the traffic flow determiner 140, the driving controller 150 may generate a driving strategy for cut-in yield control, and may reduce the speed of the host vehicle 1 (S230). In other words, the driving controller 150 may execute speed reduction control in a response to the first trigger signal, whereby extra space is secured so that the following vehicle 3 and/or the vehicle 4 traveling in the neighboring lane can cut in front of the host vehicle 1 (refer to FIG. 4B).

Thereafter, the traffic flow determiner 140 may count the number of vehicles that cut in front of the host vehicle 1 during a predetermined amount of time to detect the number of cut-ins N_{cut-in}, and may determine whether the number of cut-ins N_{cut-in} exceeds a first threshold value Nₜₕ (S240).

Upon determining that the number of cut-ins N_{cut-in} exceeds the first threshold value Nₜₕ (Yes in S240), the traffic flow determiner 140 may determine that the host vehicle 1 is impeding the surrounding traffic flow, and may compare the target speed V_{req} of the host vehicle 1 with the current speed V_{f′} of the preceding vehicle 4 (S250). Here, the preceding vehicle 4 is a vehicle that has cut in front of the host vehicle 1. Since the preceding vehicle 4 shown in FIG. 4C is the same as the vehicle 4 traveling in the neighboring lane shown in FIG. 4B, it is denoted by the same reference numeral for convenience of description.

When it is determined in step S250 that the value obtained by subtracting the speed V_{f} of the preceding vehicle 4 from the target speed V_{req} of the host vehicle 1 is less than a second threshold value Vth (No in S250), the traffic flow determiner 140 may generate a second trigger signal, and may transmit the same to the driving controller 150. Here, the second threshold value Vth is a threshold value, based on which the target speed V_{req} of the host vehicle 1 and the speed V_{f} of the preceding vehicle 4 may be regarded to have a similar speed pattern. The second threshold value Vth may be defined in advance.

Upon receiving the second trigger signal from the traffic flow determiner 140, the driving controller 150 may execute steering control for changing lanes (S260). For example, the driving controller 150 may search for a neighboring lane in which a vehicle having a speed pattern similar to the target speed V_{req} of the host vehicle 1 is traveling, and may perform a lane change in the manner of controlling the steering of the host vehicle 1 toward the found neighboring lane (refer to FIG. 4C).

In an exemplary embodiment of the present invention, how much a vehicle having a speed pattern is similar to the target speed V_{req} of the host vehicle 1 will be preset so that the speed pattern of the vehicle may range within a predetermined percentage of the target speed V_{req} of the host vehicle by experiment.

On the other hand, when it is determined in step S250 that the value obtained by subtracting the speed V_{f} of the preceding vehicle 4 from the target speed V_{req} of the host vehicle 1 is greater than or equal to the second threshold value, the driving controller 150 may control the current speed of the host vehicle 1 based on the preceding vehicle 4 according to the default autonomous driving control setting (S270).

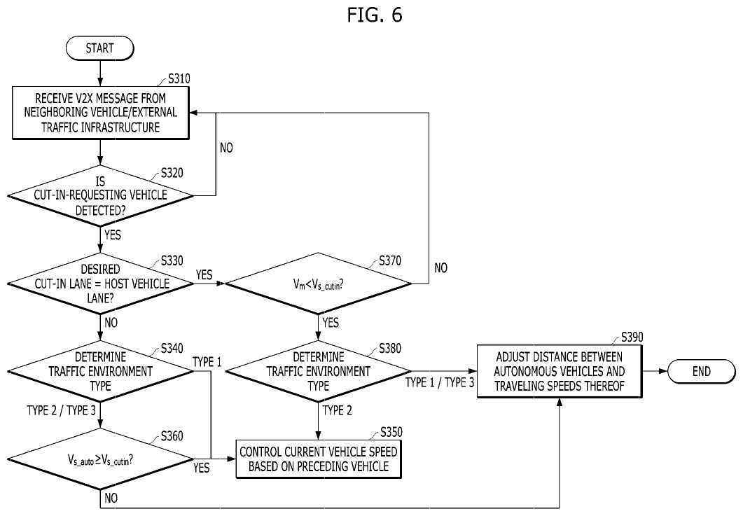

FIG. 6 is a flowchart of a vehicle control process for responding to a traffic situation according to various exemplary embodiments.

Referring to FIG. 6, when the host vehicle enters an autonomous driving activation area (Operational Design Domain (ODD)), the transceiver 120 may receive a V2X message from at least one autonomous vehicle present near the host vehicle and/or external traffic infrastructure (S310). The V2X message may include driving information on a cut-in-requesting vehicle, such as the identifier, the current speed, the current driving lane, and the desired driving lane thereof.

The traffic flow determiner 140 may detect at least one cut-in-requesting vehicle based on the received V2X message (S320), and may determine whether the desired driving lane of the detected cut-in-requesting vehicle is the driving lane of the host vehicle (hereinafter referred to as a “host vehicle lane” for convenience) (S330).

When the desired driving lane is a neighboring lane adjacent to the host vehicle lane (No in S330), the traffic flow determiner 140 may determine a traffic environment type in consideration of the current driving lane of at least one autonomous vehicle (S340). For example, the traffic flow determiner 140 may determine the traffic environment type based on the information shown in Table 1 below depending on whether at least one autonomous vehicle is currently traveling in the host vehicle lane or the neighboring lane and on whether at least one autonomous vehicle is currently traveling in each of the host vehicle lane and the neighboring lane.

TABLE 1

| | |
|---|---|
| Type 1 | At least one autonomous vehicle is present in host vehicle lane |
| | only |
| Type 2 | At least one autonomous vehicle is present in neighboring lane |
| | only |
| Type 3 | At least one autonomous vehicle is present in each of host |
| | vehicle lane and neighboring lane |

Referring to Table 1, the traffic flow determiner 140 may set the traffic environment type to “Type 1” when at least one autonomous vehicle is present in the host vehicle lane only, may set the traffic environment type to “Type 2” when at least one autonomous vehicle is present in the neighboring lane only, and may set the traffic environment type to “Type 3” when at least one autonomous vehicle is present in each of the host vehicle lane and the neighboring lane.

When it is determined in step S340 that the traffic environment type is “Type 1”, the driving controller 150 may control the current speed of the host vehicle based on the preceding vehicle according to the default autonomous driving control setting (S350).

On the other hand, when it is determined that the traffic environment type is “Type 2” or “Type 3”, the traffic flow determiner 140 may compare the speed V_{s_auto} of at least one autonomous vehicle traveling in the neighboring lane with the speed V_{s_cutin} of the cut-in-requesting vehicle (S360).

When the speed V_{s_auto} of the at least one autonomous vehicle is higher than or equal to the speed V_{s_cutin} of the cut-in-requesting vehicle (Yes in S360), the driving controller 150 may control the current speed of the host vehicle based on the preceding vehicle according to the default autonomous driving control setting (S350).

On the other hand, when the speed V_{s_auto} of the at least one autonomous vehicle is lower than the speed V_{s_cutin} of the cut-in-requesting vehicle (No in S360), the driving controller 150 may transmit a scheduling message to the at least one autonomous vehicle (S390). The scheduling message may include control information for adjusting the distance between the host vehicle and the at least one autonomous vehicle and the traveling speeds thereof, and extra space may be generated through the transmission/reception of the scheduling message therebetween so that the cut-in-requesting vehicle can enter the neighboring lane.

On the other hand, when the desired driving lane is the host vehicle lane (Yes in S330), the traffic flow determiner 140 may compare the speed Vₘ of the host vehicle with the speed V_{s_cutin} of the cut-in-requesting vehicle (S370).

When the speed Vₘ of the host vehicle is lower than the speed V_{s_cutin} of the cut-in-requesting vehicle (Yes in S370), the traffic flow determiner 140 may determine the traffic environment type (S380).

When it is determined in step S380 that the traffic environment type is “Type 2”, the driving controller 150 may control the current speed of the host vehicle based on the preceding vehicle according to the default autonomous driving control setting (S350).

In the present way, in the case of a traffic environment in which a plurality of autonomous vehicles moves simultaneously, scheduling messages are transmitted and received between the autonomous vehicles through V2X communication, whereby the distance between the autonomous vehicles and the traveling speeds thereof may be adjusted, and an optimal safe distance may be provided to allow the cut-in-requesting vehicle to enter the host vehicle lane or the neighboring lane, resulting in improvement of the surrounding traffic flow.

On the other hand, when it is determined that the traffic environment type is “Type 1” or “Type 3”, the driving controller 150 may transmit a scheduling message to the at least one autonomous vehicle (S390). The scheduling message may include control information for adjusting the distance between the host vehicle and the at least one autonomous vehicle and the traveling speeds thereof, and extra space may be generated through the transmission/reception of the scheduling message therebetween so that the cut-in-requesting vehicle can enter the host vehicle lane.

The autonomous driving control method according to the above-described embodiment may be implemented as a program which is to be executed in a computer, and may be stored in a computer-readable recording medium, and examples of the computer-readable recording medium may include Read-Only Memory (ROM), Random Access Memory (RAM), Compact Disk ROM (CD-ROM), a magnetic tape, a floppy disc, and an optical data storage.

The computer-readable recording medium can also be distributed over network-connected computer systems so that the computer-readable code is stored and executed in a distributed fashion. Also, functional programs, code, and code segments for accomplishing the above-described method may be easily devised by programmers skilled in the art to which the exemplary embodiments pertain.

As is apparent from the above description, according to at least an exemplary embodiment configured as described above, traffic flow in the vicinity of a host vehicle is determined, and a driving control strategy suitable for respective traffic situations is established, whereby hindrance to traffic flow caused by unconditional compliance with road traffic regulations may be eliminated.

Furthermore, it is possible to adjust a passive driving control strategy to actively respond to respective traffic situations, inducing smooth traffic flow in the vicinity of the host vehicle.

However, the effects achievable through the present invention are not limited to the above-mentioned effects, and other effects not mentioned herein will be clearly understood by those skilled in the art from the above description.

Although only a limited number of embodiments have been described above, various other embodiments are possible. The technical contents of the above-described embodiments may be combined into various forms as long as they are not incompatible with one another, and thus may be implemented in new embodiments.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous driving control method, comprising:
detecting, by a sensor, traffic environment information around a host vehicle;
determining, by a traffic flow determiner electrically connected to the sensor, traffic flow in a host vehicle lane and a neighboring lane adjacent to the host vehicle lane according to the traffic environment information; and
generating, by a driving controller electrically connected to the traffic flow determiner, a driving strategy according to the determined traffic flow and controlling driving of the host vehicle according to the generated driving strategy.

2. The autonomous driving control method according to claim 1, wherein the determining the traffic flow includes:
determining whether motion of a preceding vehicle is abnormal;
determining whether the host vehicle is impeding the traffic flow; and
determining whether at least one autonomous vehicle is present near the host vehicle.

3. The autonomous driving control method according to claim 2, wherein the determining whether the motion of the preceding vehicle is abnormal includes:
detecting a motion outlier of the preceding vehicle and determining whether the motion outlier is greater than a predetermined reference value;
determining whether the preceding vehicle corresponds to a predetermined type of vehicle to be avoided; and
determining whether a speed of the preceding vehicle is lower than a minimum speed limit of a road corresponding to a current location of the host vehicle.

4. The autonomous driving control method according to claim 3, wherein the controlling driving of the host vehicle according to the generated driving strategy includes:
when the traffic flow determiner concludes that the motion outlier is greater than the predetermined reference value, the preceding vehicle corresponds to the predetermined type of vehicle to be avoided, or the speed of the preceding vehicle is lower than the minimum speed limit of the road corresponding to the current location of the host vehicle,
performing, by the driving controller, a lane change of the host vehicle by increasing a speed of the host vehicle or controlling steering of the host vehicle toward the neighboring lane.

5. The autonomous driving control method according to claim 3, wherein the motion outlier includes at least one of a distance that a center portion of the preceding vehicle is deflected from a middle portion of the host vehicle lane in a lateral direction of the preceding vehicle or a number of sudden steering operations of the preceding vehicle.

6. The autonomous driving control method according to claim 2, wherein the determining whether the host vehicle is impeding the traffic flow includes:
comparing a speed of the host vehicle with a speed of a neighboring vehicle;
counting a number of vehicles that cut in front of the host vehicle during a predetermined amount of time; and
searching for the preceding vehicle having a speed pattern similar to a target speed of the host vehicle.

7. The autonomous driving control method according to claim 6, wherein the searching for the preceding vehicle is performed when the speed of the host vehicle is higher than or equal to the speed of the neighboring vehicle or when the counted number of vehicles is less than a predetermined threshold value.

8. The autonomous driving control method according to claim 6, wherein the controlling driving of the host vehicle according to the generated driving strategy includes:
when the speed of the host vehicle is lower than the speed of the neighboring vehicle, generating the driving strategy for cut-in yield control to reduce the speed of the host vehicle.

9. The autonomous driving control method according to claim 2, wherein the determining whether at least one autonomous vehicle is present includes:
receiving a V2X message from the at least one autonomous vehicle or external traffic infrastructure;
detecting a cut-in-requesting vehicle according to the V2X message and determining whether a target driving lane of the detected cut-in-requesting vehicle is the host vehicle lane; and
when the target driving lane is the host vehicle lane, comparing a speed of the host vehicle with a speed of the cut-in-requesting vehicle and transmitting a scheduling message to the at least one autonomous vehicle in consideration of a current driving lane of the at least one autonomous vehicle.

10. The autonomous driving control method according to claim 9, wherein the scheduling message includes control information to adjust a distance between the host vehicle and the at least one autonomous vehicle and traveling speeds of the host vehicle and the at least one autonomous vehicle.

11. A non-transitory computer-readable recording medium in which a program configured to be executed by the traffic flow determiner and the driving controller to perform the autonomous driving control method described in claim 1 is recorded.

12. An autonomous driving control apparatus, comprising:
a sensor configured to detect traffic environment information around a host vehicle;
a traffic flow determiner electrically connected to the sensor and configured to determine traffic flow in a host vehicle lane and a neighboring lane adjacent to the host vehicle lane according to the traffic environment information; and
a driving controller electrically connected to the traffic flow determiner and configured to generate a driving strategy according to the determined traffic flow and to control driving of the host vehicle according to the generated driving strategy.

13. The autonomous driving control apparatus according to claim 12, wherein the traffic flow determiner is configured to determine whether motion of a preceding vehicle is abnormal, to determine whether the host vehicle is impeding the traffic flow, and to determine whether at least one autonomous vehicle is present near the host vehicle.

14. The autonomous driving control apparatus according to claim 13, wherein, so as to determine whether the motion of the preceding vehicle is abnormal, the traffic flow determiner is configured to perform:
detecting a motion outlier of the preceding vehicle and determining whether the motion outlier is greater than a predetermined reference value;
determining whether the preceding vehicle corresponds to a predetermined type of vehicle to be avoided; and
determining whether a speed of the preceding vehicle is lower than a minimum speed limit of a road corresponding to a current location of the host vehicle

15. The autonomous driving control apparatus according to claim 14, wherein,
when the traffic flow determiner concludes that the motion outlier is greater than the predetermined reference value, the preceding vehicle corresponds to the predetermined type of vehicle to be avoided, or the speed of the preceding vehicle is lower than the minimum speed limit of the road corresponding to the current location of the host vehicle,
the driving controller is configured to perform a lane change of the host vehicle by increasing a speed of the host vehicle or controlling steering of the host vehicle toward the neighboring lane.

16. The autonomous driving control apparatus according to claim 14, wherein the motion outlier includes at least one of a distance that a center portion of the preceding vehicle is deflected from a middle portion of the host vehicle lane in a lateral direction of the preceding vehicle or a number of sudden steering operations of the preceding vehicle.

17. The autonomous driving control apparatus according to claim 13, wherein the traffic flow determiner compares a speed of the host vehicle with a speed of a neighboring vehicle, counts a number of vehicles that cut in front of the host vehicle during a predetermined amount of time, and searches for the preceding vehicle having a speed pattern similar to a target speed of the host vehicle to determine whether the host vehicle is impeding the traffic flow.

18. The autonomous driving control apparatus according to claim 17, wherein the traffic flow determiner searches for the preceding vehicle when the speed of the host vehicle is higher than or equal to the speed of the neighboring vehicle or when the counted number of vehicles is less than a predetermined threshold value.

19. The autonomous driving control apparatus according to claim 17, wherein, when the speed of the host vehicle is lower than the speed of the neighboring vehicle, the driving controller is configured to generate the driving strategy for cut-in yield control to reduce the speed of the host vehicle.

20. The autonomous driving control apparatus according to claim 13, further including:
a transceiver configured to receive a V2X message from the at least one autonomous vehicle or external traffic infrastructure,
wherein the traffic flow determiner detects a cut-in-requesting vehicle according to the V2X message, determines whether a target driving lane of the detected cut-in-requesting vehicle is the host vehicle lane, and when the target driving lane is the host vehicle lane, compares a speed of the host vehicle with a speed of the cut-in-requesting vehicle,
wherein the driving controller is configured to transmit a scheduling message to the at least one autonomous vehicle through the transceiver in consideration of a result of comparison between the speed of the host vehicle and the speed of the cut-in-requesting vehicle and of a current driving lane of the at least one autonomous vehicle, and
wherein the scheduling message includes control information to adjust a distance between the host vehicle and the at least one autonomous vehicle and traveling speeds of the host vehicle and the at least one autonomous vehicle.
